(19) United States
(12) Patent Application Publication
(10) Pub. No.: US 2005/0198398 A1
(43) Pub. Date: Sep. 8, 2005

(54) Methods and systems for managing a network while physical components are being provisioned or de-provisioned

(76) Inventors: Thomas Patrick Bishop, Austin, TX (US); Michael A. Martin, Round Rock, TX (US); Robert F. Tulloh, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/761,909

(22) Filed: Jan. 21, 2004

(51) Int. Cl. G06F 15/16

(52) U.S. Cl. 709/249

(57) ABSTRACT

Methods and systems of managing a network can be used in which physical components may be provisioned or de-provisioned without having to manually reconfigure a logical instrument. Logical instruments may be used to monitor or control an application environment. The logical instruments may be coupled to logical objects, which in turn are coupled to physical model objects, which in turn correspond to physical components. Host agents may reside on the physical components to actuate or have actuated a physical component. From a perspective of an operator or a program optimizing or otherwise managing an application environment on a network, the logical instruments appear as static variables (values can change, but the variable itself does not) where dynamic changes to physical components may occur but are transparent to the operator or program.

### FIELD OF THE INVENTION

The invention relates in general to methods and systems for managing a network, and more particularly to methods and systems for managing an application environment on a network.

### DESCRIPTION OF THE RELATED ART

Virtualization provides a mechanism where resources of the same type (e.g., memory) are tied behind a virtualization interface. The machinery used for virtualization is to make sure that, whenever needed, the virtualized resource is present. Virtualization starts at the component level and abstracts to a higher level (away from the physical component level).

Virtualization has limitations because of its static structure. Virtualization requires service interfaces between the requesters and the providers of a service. The interfaces are hardware intensive. If any resources are changed (i.e., added, removed, or replaced), the new collection of resources for virtualization is manually reconfigured to reflect the new collection. Nearly all systems, including those that do or not use virtualization, do not handle situations where resources can come and go, such as those that occur in real world computing environments.

### SUMMARY

Methods and systems of managing a network can be used in which physical components may be provisioned or de-provisioned without having to manually reconfigure a logical instrument. Logical instruments may be used to monitor or control an application environment. The logical instruments may be coupled to logical objects, which in turn are coupled to physical model objects, which in turn correspond to physical components. Host agents may reside on the physical components to actuate or have actuated a physical component. The logical instruments may reside at a relatively high level of abstraction to keep the managing or optimizing programs (for use with the network) from dealing with variables that would otherwise come and go with the components. Also, unlike virtualization, manual reconfiguration of interfaces is not needed. Even if physical components are provisioned or de-provisioned, predictive models may continue to be used after provisioning or de-provisioning without having to place the system into a learning mode. Also, other than physically added or removing physical components, the rest of the method for managing the application environment can be automated. In this manner, dynamic changes can be affected that appear transparent from the perspective of an operator or program that manages or optimizes an application environment.

In one set of embodiments, a method of managing a network can include provisioning or de-provisioning a physical component on the network. The method can also include automatically updating a logical object to reflect the provisioning or de-provisioning of the physical component.

In still another set of embodiments, a method of managing a network can include using a logical instrument with a first set of physical components. The method can also include creating a second set of physical components that is different from the first set of physical components. The method can further include using the logical instrument with the second set of physical components. The logical instrument may or may not be manually reconfigured between using the logical instrument on the first set of physical components and using the logical instrument on the second set of physical components.

In yet another set of embodiments, data processing system readable media can comprise code that includes instructions for carrying out the methods and may be used on the systems.

In a further set of embodiments, a system for managing a network can include a logical instrument, a logical object, and physical model object(s). The physical model object(s) can correspond to physical component(s). The logical object can relate the physical model object(s) to the logical instrument.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a hardware configuration of a system for managing an application that runs on a network.

FIG. 2 includes an illustration of a hardware configuration of the application management appliance in FIG. 1.

FIG. 3 includes an illustration of a software architecture for a logical instrument to be used with a set of physical components in accordance with an embodiment of the present invention.

FIG. 4 includes an illustration of a process flow diagram for provisioning or de-provisioning a physical component used in conjunction with a logical instrument.

FIGS. 5 and 6 includes illustration of process flow diagrams for adding and removing, respectively, a physical component to the network when the physical component is used in conjunction with a logical instrument.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Methods and systems of managing a network can be used in which physical components may be provisioned or de-provisioned without having to manually reconfigure a logical instrument. Logical instruments may be used to monitor or control an application environment. The logical instruments may be coupled to logical objects, which in turn are coupled to physical model object, which in turn correspond to physical components. Host agents, which are software agents, may reside on the physical components to actuate or have actuated a physical component.

The logical instruments may reside at a relatively high level of abstraction to keep the managing or optimizing programs (for use with the network) from dealing with variables that would otherwise come and go with the components. Also, unlike virtualization, manual reconfiguration of interfaces is not needed. Even if physical components are provisioned or de-provisioned, predictive models may continue to be used after provisioning or de-provisioning without having to place the system into a learning mode. Also, other than physically adding or removing physical components, the rest of the method for managing the application environment can be automated. In this manner, dynamic changes can be affected that appear transparent from the perspective of an operator or program that manages or optimizes an application environment.

A few terms are defined or clarified to aid in understanding the descriptions that follow. The term “application environment” is intended to mean any and all hardware, software, and firmware used by an application. The hardware can include servers and other computers, data storage and other memories, switches and routers, and the like. The software used may include operating systems.

The term “component” is intended to mean any part of a system in which an application may be running. Components may be hardware, software, firmware, or virtual components. Many levels of abstraction are possible. For example, a server may be a component of a system, a CPU may be a component of the server, a register may be a component of the CPU, etc. For the purposes of this specification, component and resource are used interchangeably.

The term “de-provisioning” is intended to mean that a physical component is no longer active within a network. De-provisioning includes placing a component into an idling, a maintenance, a standby, or a shut-down state or removing the physical component from the network

The term “instrument” is intended to mean a gauge or control that can monitor or control at least part of a network.

The term “logical,” when referring to an instrument or object, is intended to mean an instrument or object that does necessarily not correspond to a single physical component that otherwise exists or that can be added to a network. For example, a logical instrument may be coupled to a plurality of gauges on physical components.

The term “physical,” when referring to an instrument, object, or component, is intended to mean an instrument, object, or component that exists outside of (separate from) a logical instrument or logical object to which it is associated.

The term “provisioning” is intended to mean that a physical component is in an active state within a network. Provisioning includes placing a component in an active state or adding the physical component to the network.

As used herein, the terms “comprises,” “comprising,” “includes,” “including,” “has,” “having” and any variations thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting exemplary hardware architecture for using embodiments of the present invention is described. After reading this specification, skilled artisans will appreciate that many other hardware architectures can be used in carrying out embodiments described herein and to list every one would be nearly impossible.

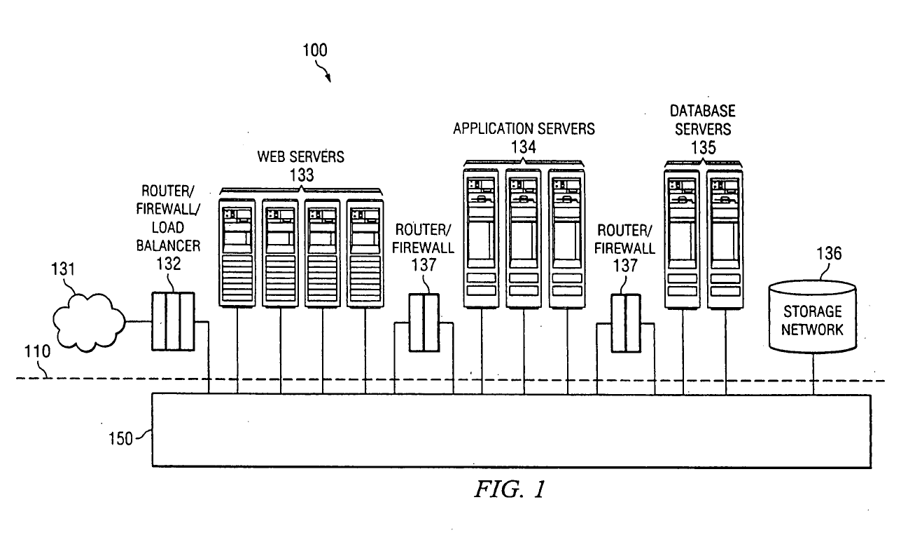

FIG. 1 includes a hardware diagram of a system 100. The system 100 includes a network 110, which is the portion above the dashed line in FIG. 1. The network 110 includes the Internet 131 or other network connection, which is coupled to a router/firewall/load balancer 132. The network further includes Web server computers 133, application server computers 134, and database server computers 135. Other computers may be part of the network 110 but are not illustrated in FIG. 1. The network 110 also includes storage network 136 and router/firewalls 137. Although not shown, other additional components may be used in place of or in addition to those components previously described. Each of the components 132-137 is bi-directionally coupled in parallel to an appliance (apparatus) 150. In the case of router/firewalls 137, the inputs and outputs from such router/firewalls 137 are connected to apparatuses 150. Substantially all the traffic for components 132-137 in network 110 is routed through the appliance 150. Software agents may or may not be present on each of components 132-137. The software agents can allow the appliance 150 to monitor and control at least a part of any one or more of components 132-137. Note that in other embodiments, software agents may not be required in order for the appliance 150 to monitor and control the components.

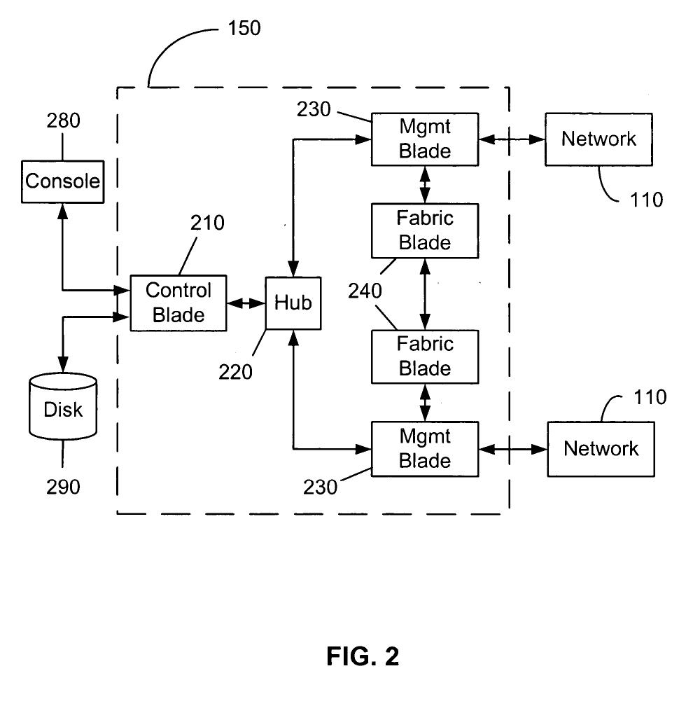

FIG. 2 includes a hardware depiction of the appliance 150 and how it is connected to other components of the system. The console 280 and disk 290 are bi-directionally coupled to a control blade 210 within the appliance 150. The console 280 can allow an operator to communicate with the appliance 150. Disk 290 may include data collected from or used by the control blade 210. The control blade 210 is bi-directionally coupled to a hub 220. The hub 220 is bi-directionally coupled to each management blade 230 within the appliance 150. Each management blade 230 is bi-directionally coupled to the network 110 and fabric blades 240. Two or more of the fabric blades 240 may be bi-directionally coupled to one another.

Although not shown, other connections and additional memory may be coupled to each of the components within the appliance 150. Further, nearly any number of management blades 230 may be present. For example, the appliance 150 may include one or four management blades 230. When two or more management blades 230 are present, they may be connected to different parts of the network 110. Similarly, any number of fabric blades 240 may be present and under the control of the management blades 230. In still another embodiment, the control blade 210 and hub 220 may be located outside the appliance 150, and nearly any number of apparatuses 150 may be bi-directionally coupled to the hub 220 and under the control of control blade 210.

The control blade 210, the management blades 230, or both may include a central processing unit (“CPU”) or controller. Therefore, the appliance 150 is an example of a data processing system. Although not shown, other connections and memories (not shown) may reside in or be coupled to any of the control blade 210, the management blade 230, or both. Such memories can include, content addressable memory, static random access memory, cache, first-in-first-out (“FIFO”), other memories or any combination thereof. The memories, including disk 290 can include media that can be read by controller, CPU, or both. Therefore, each of those types of memories includes a data processing system readable medium.

Portions of the methods described herein may be implemented in suitable software code that may reside within or accessibly to the appliance 150. The instructions in an embodiment of the present invention may be contained on a data storage device, such as a hard disk, a DASD array, magnetic tape, floppy diskette, optical storage device, or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another apparatus substantially identical to appliance 150 or by a computer, such as any one or more illustrated in FIG. 1. Additionally, a computer program or its software components with such code may be embodied in more than one data processing system readable medium in more than one computer.

Communications between any of the components 132-137 and appliance 150 in FIG. 1 can be accomplished using electronic, optical, radio-frequency, or other signals. For example, when an operator is at the console 280, the console 280 may convert the signals to a human understandable form when sending a communication to the operator and may convert input from a human to appropriate electronic, optical, radio-frequency, or other signals to be used by and one or more of the components 132-137 and appliance 150.

Before addressing a software architecture, some considerations for the design are described to provide a better foundation for understanding the present invention.

Optimization of a network, and more particularly, an application environment on the network, can be accomplished with a static, never changing configuration and set of components. In reality, the static, never changing configuration and set of components cannot be achieved. Components are being provisioned, de-provisioned, or both. Note that provisioning and de-provisioning components includes adding and removing components. Currently available managing or optimization algorithms focus at low levels, such as the component level, and provisioning and de-provisioning components cause variables to come and go within the algorithm. The algorithms are not designed to work, yet alone work well, with variables that come and go.

As described herein, the problem of optimizing an application environment is approached in a fundamentally different way from a nearly opposite direction. Virtualization starts at the physical component level and works toward a higher level of abstraction. Unlike virtualization, the problem is addressed herein by starting at a high level of abstraction and working downward. In this manner, the physical environment is “hidden” under a logical abstraction where individual physical components can come and go, but the logical abstraction at the high level remains the same. A view of the logical instruments appears to the user and optimization software to be a static collection of components.

In one implementation, logical instruments at a high abstraction level allows the application environment to be managed or optimized while still allowing physical components to be provisioned, de-provisioned, or both. Logical instruments can be created, which from a management or optimization standpoint, appear to be static. The logical instruments map down to lower level objects that may interact with software agents on the physical components (“host agents”). Optimization of an application environment can use the logical instruments more effectively because the logical instrument appears to be static to the optimization algorithm. An example of optimization is described in more detail in U.S. application Ser. No. ______, entitled “Method and System for Optimization of Controls” by Martin et al. filed on ______, (“Optimization Application”).

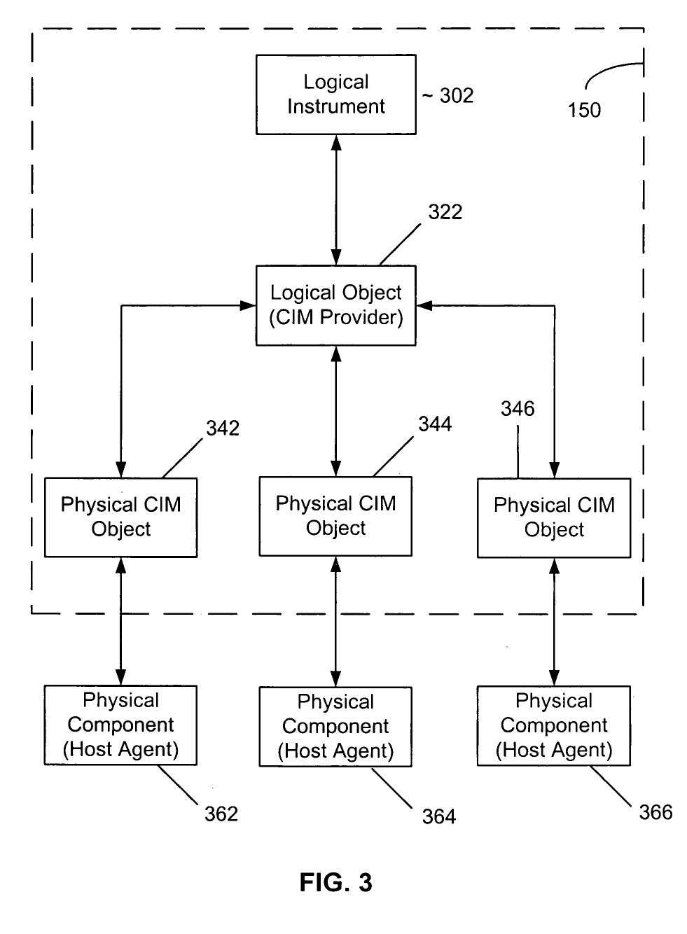

Attention is now directed to a non-limiting, exemplary software architecture in accordance with one embodiment of the present invention. An exemplary software architecture is illustrated in FIG. 3. A logical instrument 302 is bi-directionally coupled to a logical object 322, which can be a common information model (CIM) object. A CIM provider can be responsible for creating instances of physical CIM objects (also called physical model objects) 342, 344, and 346, which are CIM objects of the physical components (also called elements). Each of physical CIM objects 342, 344, and 346 are bi-directionally coupled to the logical object 322.

Although the CIM provider is shown as being part of the logical object 322, the CIM provider may be separate and not part of the logical object 322. The CIM provider may also be responsible for providing the mapping of the logical object 322 to its matched physical CIM objects 342, 344, and 346. The physical implementation used for mapping may use the specific mechanisms that can vary depending on the particular type of logical instrument and physical component.

Each of the physical CIM objects 342, 344, and 346 are bi-directionally coupled to the physical components 362, 364, and 366. Depending on the type of instrument, the host agents on the physical components 362, 364, and 366 may be configured to send readings or other data from the physical component 362, 364, or 366 to the appliance 150 or to receive requests for action from the appliance 150 to be performed by host agent's corresponding physical component 362, 364, or 366.

Referring to FIGS. 2 and 3, in one embodiment, the logical instrument 302, logical object 322, physical CIM objects 342, 344, and 346, and CIM provider may reside on the appliance 150, and more specifically, on the control blade 210. The logical instrument 302 may be a control or gauge accessible to an operator at the console 280. A set of logical instruments can be used by the operator at the console 280 as a logical dashboard for the application environment. In one embodiment, logical instruments may be in the form of slider bars, and the operator can use his or her mouse or other electronic pointer to move an icon on one of the slider bars to change the value on the control.

The host agents 362, 364, and 366 may reside on or near a physical component (e.g., on an external disk drive accessible by the physical component) and typically are outside of the appliance 150. In FIG. 2, the host agents 362, 364, and 366 lie within the network 110 and communicate through the management blades 230 within the appliance 150. In other embodiments, one or more of the functions performed by the control blade 210 may be performed by the management blade(s) 230.

In one specific embodiment, software running on the control blade 210 interacts with a set of physical components via host agents. An object database includes the logical object 322, which can be a CIM instance, and the physical CIM objects 342, 344, and 346. The CIM provider can be responsible for creating socket connections to the host agents, where the host agents instruct their corresponding physical components to send data to the appliance 150 or to perform operations. Input from an operator at the console 280, requests from an optimization or management program, or input or requests from almost any source can interact with the logical CIM object 322. Code using the logical CIM object 322 converts the input or request at the logic (higher) level and maps the input or request down to physical (lower) level, which includes the collection of physical CIM objects 342, 344, and 346. Instruction(s) corresponding to the input or request (at the logic level) are sent to host agents on the physical components to execute the instructions to affect the action from the input or request.

In one embodiment, the object database includes many CIM objects which are part of classes that implement the various behaviors which in turn causes instruction(s) to be sent through a socket layer to the host agent. After the instruction(s) have been successfully executed, the host agent(s) on the physical component(s) may send a communication back to the appliance 150 (e.g., control blade 210, management blade 230, or both) informing the appliance 150 of such. Similarly, if the instruction(s) are not successfully executed, the host agent may send a communication back to the appliance 150 (control blade 210, management blade 230, or both) informing the appliance 150 of such.

The use of the logical object 322 allows the analytics (i.e., logical instruments) in the control blade 210 (used to monitor and control the network 110) to avoid direct interaction with the physical CIM objects 342, 344, and 346.

Many other embodiments are possible. The illustrations provided herein are to aid in the understanding, and not to limit, the present invention. The architecture as illustrated in FIG. 3 can be replicated for nearly any number of logical instruments. The logical instruments can include logical gauges, logical controls (“knobs”), or both.

The logical instrument 302 can represent nearly anything. The logical instruments can be partitioned into component types. A set of logicals (logical instrument and logical object) and physicals (physical CIM objects, host agents, and physical components) may be associated with a web server computer, another set of logicals and physicals with an application server computer, and yet another set of logicals and physicals for database server computers. The system and method may be used to abstract across platform types. Apache, IAS, Iplanet may be examples of web server platforms. A method and system can be made to address the different communications protocols, etc., so that a logical instrument can work with any combination of physical components for the same resource type regardless whether the physical components are for the same or different platforms. In the web server example, a logical instrument may determine an average response time for serving a requested page, where the average response time is determined using data from the web servers for different platforms.

For gauges, the logical instrument 302 may include an average, a sum, or other collective representation of information for the same type of component. For example, the logical instrument 302 may include the number of instructions processed by all server computers in a server farm, an average access time from memory, etc. Below is a table for some logical instruments. Note that many other logical instruments may be used, and the list is not meant to illustrate. Also, pairs of logical instruments are not required. In other words, a logical instrument for an average value may or may not have a corresponding logical instrument reporting a summed value for nearly the same parameter (e.g., workload, user connections, etc.).

TABLE 1
EXEMPLARY LOGICAL INSTRUMENTS

| Average | Sum |
|---|---|
| Average CPU utilization % | Total CPU capacity |
| Average disk utilization % | Total disk capacity |
| Average disk I/O rate | Total disk I/O rate |
| Average workload | Number of user connections |

The logical instrument 302 may also include a control. Controls can be similar to the gauges in that a value may represent an average or sum, but in addition, may include a setpoint (similar to setting the temperature of a thermostat).

For some of the logical instruments, the scale for the logical instrument 302 is relatively straightforward. For example, a percentage may be displayed on a scale from 0-100. However, for other logical instruments, the scale needs to accommodate for the potential of adding more components of the same type. This may be particularly true for logical instruments that work using summed values. For example, a current network configuration may have two server computers with a CPU capacity of 4 million instructions/second. One more server computers may be added at a later time. The logical instrument 302 for CPU capacity may have a scale that goes up to 6 million instructions/second to accommodate another server computer that may be later added. The difference between the capacity with the current configuration and the potential future configuration is referred to as headroom. Note that the concept of using headroom is similar to an automobile having a speedometer that goes up to 200 Km/hour even though the automobile may only be capable of reaching 150 Km/hour. In the server example, the headroom is the portion between 4 and 6 million instructions/second. A control space definition (as described in the Optimization Application) can be used to define a narrower range to be used by an optimization engine even though the logical instrument 302 may be designed to have a larger range.

After the logical instruments are created, a learning session can be used to build neural network(s) or statistical predictive model(s). The neural network(s) or predictive model(s) can learn the relationships (behavioral and otherwise) between the logical instruments and physical components. After learning is completed, optimization can be performed during normal operation of the network by using the logical instruments.

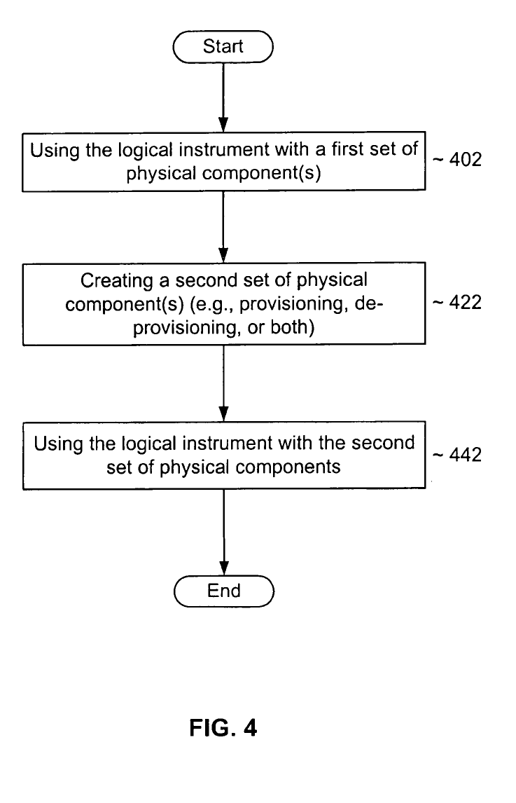

In one embodiment that will be described in more detail with respect to FIG. 4, the logical instrument 302 can be a control for the CPU capacity. At console 280, an operator can change the CPU capacity such that a server computer may be provisioned or de-provisioned. From the perspective of the operator at console 280 or an optimization program using logical instrument 302, the CPU capacity has changed. The provisioning or de-provisioning of the physical component is hidden from the operator and optimization program. They do not need to know or may not even care that another server computer within the server farm has just been provisioned or de-provisioned. In this manner, optimization can be performed on a static set of logical instruments even though physical components are being provisioned and de-provisioned during normal operation. Therefore, optimization can be used with dynamic changes to physical components.

At a later time, the range for a logical instrument 302 may be changed or a new logical instrument may be created. In one embodiment, the logical instrument 302 may be for CPU capacity and has an upper limit of 6 million instructions/second. Two more server computers having significantly faster CPUs may be added to the server farm. With the new configuration, CPU capacity may now be 14 million instructions/second. To allow for some headroom, the logical instrument 302 may be changed to have an upper limit of 20 million instructions/second. After a change in the logical instrument 302 is made, the system may be placed into a learning mode to learn how the network works to build or revise neural networks or other predictive models for the newly changed upper limit on the logical instrument 302.

After reading the specification, skilled artisans will appreciate that the concepts described herein can be extended to logical instruments for other parameters, such as user connections, memory size, disk space, etc. The number and types of logical instruments can be tailored to the specific application contemplated.

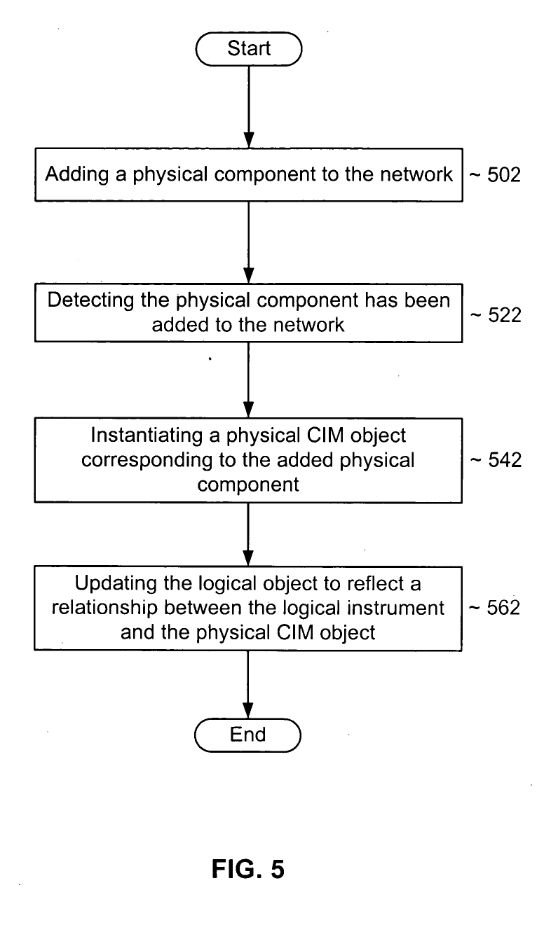

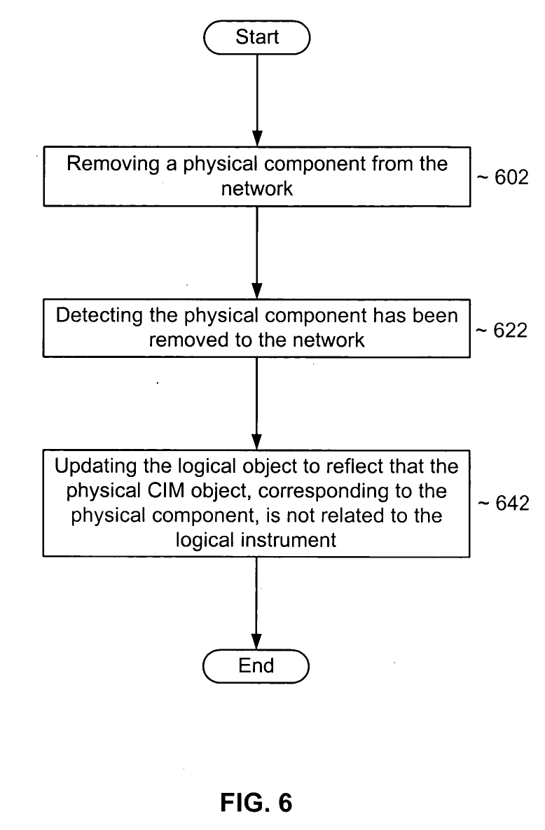

As previously mentioned, the architecture as illustrated in the embodiment in FIG. 3 can be used to perform processes of provisioning and de-provisioning physical components (FIG. 4), and in more specific embodiments, to adding physical components (FIG. 5) and removing physical components (FIG. 6). The processes are described in more detail below.

Referring to FIG. 4, the method can include using the logical instrument with a first set of physical component(s) (block 402). The method can also include creating a second set of physical component(s) (e.g., provisioning, de-provisioning, or both) (block 404). The method can further include using the logical instrument with the second set of physical components (block 406).

FIG. 4 is described in more detail with respect to a specific, non-limiting example where logical instrument 302 corresponds to CPU capacity, which is being changed. Physical components 362, 364, and 366 can correspond to server computers, each capable of processing up to 2 million instructions/second. The logical instrument 302 may be set for 3 million instructions/second. Physical components 362 and 364 are provisioned, and physical component 366 is de-provisioned because only two server computers are needed. Therefore, the system is using a first set of physical components that includes physical components 362 and 364.

At console 280, an operator can use the logical instrument 302 to change the CPU capacity from 3 million instructions/second to 5 million instructions/second. After the setting for the logical instrument 302 passes across the 4 million instructions/second threshold, the setting exceeds the capacity of physical components 362 and 364. The logical object 322 includes a mapping to physical. CIM objects 342, 344, and 346, which in turn correspond to host agents on the physical components 362, 364, and 366.

The change in CPU capacity causes an instruction from the control blade 210 to be sent via management blade(s) 230 over network 110 to the host agents on physical component(s) 362, 364, and 366 so that all three server computers are provisioned. The instruction may be sent only to the host agent on physical component 366 or to host agents for physical components 362, 364, and 366. If the instruction is sent to host agents on physical components 362 and 364, the instruction is effectively ignored because the instruction was only meant specifically for physical component 366 or the instruction is for the provisioning which is received by already provisioned server computers (physical components 362 and 364). By provisioning the physical component 366, the system has created a second set of physical components (362, 364, and 366) for use with the logical instrument 302. The system can then use that second set of physical components as previously described.

After reading this specification, skilled artisans will appreciate that the reverse operation, taking CPU capacity back to 3 million instructions/second would be just the reverse. One of physical components 362, 364, or 366 would be de-provisioned.

Note that the definitions of provisioning and de-provisioning are broad. The prior embodiment may have maintained physical connectivity to the physical components 362, 364, and 366. In other words, the physical components are part of network 110, and the operations of provisioning and de-provision may have corresponded to booting up a computer and shutting down or otherwise placing a computer in an inactive state. In other embodiments, provisioning and de-provisioning may include physically adding or removing physical components from the network 110.

FIG. 5 is directed to a method in which provisioning includes adding a physical component to be used with the logical instrument 302. The method can include adding a physical component to the network (block 502). In one embodiment, the physical component 366 may not initially be connected to the network 110 but is later added.

The method can also include detecting the physical component has been added to the network (block 504). The detection can be performed by the control blade 210 and is similar to a Wizard on a personal computer used for detecting when new hardware is added to a personal computer.

The method can further include instantiating a physical CIM object 346 corresponding to the added physical component 366 (block 542). In one embodiment, the control blade 210 can invoke an auto-instantiation mechanism. The auto-instantiation mechanism, such as the CIM provider, is responsible for creating physical CIM object 346 that corresponds to the physical component 366 that has recently been added to the network 110.

The method can include updating the logical object 322 to reflect a relationship between the logical instrument 302 and the physical CIM object 344 (block 562). The logical CIM object 322 can record interest in a physical resource type, such as web server computer CPU capacity. When a change in the physical CIM object for the resource type of the logical instrument 302 occurs, the physical CIM object 366 can post an event (similar to installing hardware on a personal computer) where the event notifies the logical object(s) (e.g., logical object 322) using that resource type regarding the newly added physical component 366. The logical object 322 can update the mapping to now include the physical CIM object 346 for the corresponding physical component 366.

If the logical instrument 302 was configured with some headroom, adding another physical component, such as physical component 366 may not require performing a learning session on the new configuration. However, if the newly added physical component causes the limits of the logical gauge 302 or control definition space to be exceeded, the limits on the logical gauge 302 or control definition space may need to be changed and a learning session may be performed.

De-provisioning can include removing a physical component from the network. Referring to FIG. 6, the method can include removing a physical component from the network (block 602). For example, physical component 366 may be removed from the network 110. The method can also include detecting the physical component has been removed to the network (block 622). The physical CIM object 346 may detect that the physical component 366 is removed from the network 110.

The method can further include updating the logical object to reflect that the physical CIM object, corresponding to the physical component, is not currently related to the logical instrument (block 642). The physical CIM object 346 may post an event that can be detected by logical CIM object(s), such as logical CIM object 366, that are interested in the resource type of physical component 366. Logical CIM object 322 can be updated to reflect that physical component 366 is no longer available. Note that more than one instrument may be affected when one physical component is added or removed from the network 110.

Many of the operations described in FIGS. 4-6 can be performed automatically with little or no human intervention. For example, an optimization software program can be used to provision or de-provision physical components based on readings, settings, or both of the logical instruments. After physical components are added or removed from the network 110, auto-instantiation of CIM objects and updating mapping can be performed without any human intervention. Also, the logical instrument 302 may not need to be changed solely because an underlying physical component was provisioned or de-provisioned.

Note that not all of the activities described above are required, that an element within a specific activity may not be required, and that further activities may be performed in addition to those illustrated. Still further, the order in which each of the activities are listed are not necessarily the order in which they are performed. After reading this specification, skilled artisans will be capable of determining what activities can be used for their specific needs.

The logical-physical instrument architecture has benefits over virtualization. The new architecture can allow for monitoring and controlling an application environment across heterogeneous component types and components of different types and sizes without having to rationalize all of them into a single service interface. Also, physical components can be provisioned and de-provisioned, including adding and removing physical components, without having to create new interfaces or manually reconfigure existing ones.

The logical instruments also allow for better automated control and optimization of application environments. Physical components can be provisioned and de-provisioned while still optimizing or otherwise managing the application environment because the logical instruments appear static to the automated control or optimization programs. With the higher levels of abstraction, such as with logical instrument, the provisioning and de-provisioning of physical component can be transparent to the logical instruments and programs that operate using them. Further, those programs do not have to deal with variables coming and going as physical components are provisioned and de-provisioned.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A method of managing a network comprising:
provisioning or de-provisioning a physical component on the network; and
automatically updating a logical object to reflect the provisioning or de-provisioning of the physical component.

2. The method of claim 1, further comprising:
detecting that the physical component has been added to the network; and
instantiating a physical model object corresponding to the physical component.

3. The method of claim 2, wherein detecting and instantiating are performed automatically.

4. The method of claim 2, wherein updating the logical object comprises relating the physical model object to the logical object.

5. The method of claim 1, further comprising determining that the physical component has been removed from the network.

6. An apparatus operable for carrying out the method of claim 1.

7. A method of managing a network comprising:
using a logical instrument with a first set of physical components;
creating a second set of physical components that is different from the first set of physical components; and
using the logical instrument with the second set of physical components, wherein the logical instrument is not manually reconfigured between using the logical instrument with the first set of physical components and using the logical instrument with the second set of physical components.

8. The method of claim 7, wherein the logical instrument is not changed between using the logical instrument with the first set of physical components and using the logical instrument with the second set of physical components.

9. The method of claim 7, wherein each of the physical components within the first and second sets of physical components comprises a software agent coupled to the instrument.

10. The method of claim 7, wherein the logical instrument includes a logical gauge.

11. The method of claim 7, wherein the logical instrument includes a logical control.

12. The method of claim 7, wherein all physical components within the first and second sets of physical components are of a same type.

13. The method of claim 7, wherein:
creating a second set of physical components comprises adding a first physical component to the network;
wherein the method further comprises:
detecting the first physical component has been added to the network;
instantiating a first physical model object corresponding to the first physical component; and
updating a logical object to reflect a relationship between the first physical model object and the instrument.

14. The method of claim 13, wherein detecting, instantiating, and updating are performed automatically.

15. The method of claim 7, wherein:
creating a second set of physical components comprises removing a first physical component to the network;
wherein the method further comprises:
determining the first physical component has been removed the network; and
updating a logical object to reflect that the first physical model object is not related to the instrument.

16. The method of claim 15, wherein detecting and updating are performed automatically.

17. An apparatus operable for carrying out the method of claim 7.

18. A data processing system readable medium having code for estimating usage of a component within a network, wherein the code is embodied within the data processing system readable medium, the code comprising:
an instruction for provisioning or de-provisioning a physical component on the network; and
an instruction for updating a logical object to reflect the provisioning or de-provisioning of the physical component.

19. The data processing system readable medium of claim 18, wherein the code further comprises:
an instruction for detecting that the physical component has been added to the network; and
an instruction for instantiating a physical model object corresponding to the physical component.

20. The data processing system readable medium of claim 19, wherein the instruction for updating the logical object comprises an instruction for relating the physical model object to the logical object.

21. The data processing system readable medium of claim 18, wherein the code further comprises an instruction for determining that the physical component has been removed from the network.

22. A data processing system readable medium having code for estimating usage of a component within a network, wherein the code is embodied within the data processing system readable medium, the code comprising:
an instruction for using a logical instrument with a first set of physical components;
an instruction for creating a second set of physical components that is different from the first set of physical components; and
an instruction for using the logical instrument with the second set of physical components, wherein the logical instrument is not manually reconfigured between using the logical instrument with the first set of physical components and using the logical instrument with the second set of physical components.

23. The data processing system readable medium of claim 22, wherein the logical instrument is not changed between using the logical instrument with the first set of physical components and using the logical instrument with the second set of physical components.

24. The data processing system readable medium of claim 22, wherein each of the physical components within the first and second sets of physical components comprises a software agent coupled to the instrument.

25. The data processing system readable medium of claim 22, wherein the logical instrument includes a logical gauge.

26. The data processing system readable medium of claim 22, wherein the logical instrument includes a logical control.

27. The data processing system readable medium of claim 22, wherein all physical components within the first and second sets of physical components are of a same type.

28. The data processing system readable medium of claim 22, wherein:
the instruction for creating a second set of physical components comprises an instruction for adding a first physical component to the network;
wherein the code further comprises:
an instruction for detecting the first physical component has been added to the network;
an instruction for instantiating a first physical model object corresponding to the first physical component; and
an instruction for updating a logical object to reflect a relationship between the first physical model object and the instrument.

29. The data processing system readable medium of claim 22, wherein:
the instruction for creating a second set of physical components comprises an instruction for removing a first physical component to the network;
wherein the code further comprises:
an instruction for determining the first physical component has been removed the network; and
an instruction for updating a logical object to reflect that the first physical model object is not related to the instrument.

30. A system for managing a network comprising:
a logical instrument;
at least one physical model object corresponding to at least one physical component; and
a logical object, wherein the logical object relates the physical model object to the logical instrument.

31. The system of claim 30, wherein the logical instrument is coupled to a plurality of physical model objects, wherein all of the physical model objects are of a same type.

32. The system of claim 30, further comprising the at least one physical component.

33. The system of claim 32, wherein the at least one physical component comprises a software agent coupled to the at least one physical model object.
